(19) United States
(12) Patent Application Publication
(10) Pub. No.: US 2024/0318323 A1
(43) Pub. Date: Sep. 26, 2024

(54) APPARATUS AND METHOD FOR GREEN HYDROGEN PRODUCTION USING SUBMERGED DESALINATION SYSTEM

(71) Applicant: Natural Ocean Well Co., Culver City, CA (US)

(72) Inventor: Michael M. Porter, Culver City, CA (US)

(21) Appl. No.: 18/734,848

(22) Filed: Jun. 5, 2024

Related U.S. Application Data
(63) Continuation of application No. PCT/US2022/051619, filed on Dec. 2, 2022.
(60) Provisional application No. 63/287,013, filed on Dec. 7, 2021.

(51) Int. Cl. C25B 1/04; C02F 1/44; C02F 7/00; C02F 103/08; C25B 9/65; C25B 15/08

(52) U.S. Cl. CPC C25B 1/04; C02F 1/441; C02F 7/00; C25B 9/65; C25B 15/085; C02F 2103/08; C02F 2201/009

(57) ABSTRACT

A green hydrogen production system and method uses an offshore platform, an offshore renewable energy source, a submerged water desalination apparatus and a water electrolysis apparatus to produce hydrogen and oxygen using power from the renewable energy source and desalinated water from the submerged water desalination apparatus. The system and method enable green hydrogen production with reduced energy use or capital cost compared to onshore systems and systems that do not employ a submerged water desalination apparatus.

### CROSS REFERENCE TO RELATED APPLICATIONS

This application is a continuation under 35 U.S.C. § 111 of International Application No. PCT/US2022/051619 filed Dec. 2, 2022 and entitled “APPARATUS AND METHOD FOR GREEN HYDROGEN PRODUCTION USING SUBMERGED DESALINATION SYSTEM”, which claims priority under 35 U.S.C. § 119 to and the benefit of U.S. Provisional Application Ser. No. 63/287,013 filed Dec. 7, 2021 and entitled “APPARATUS AND METHOD FOR GREEN HYDROGEN PRODUCTION USING SUBMERGED DESALINATION SYSTEM”, the disclosures of which are incorporated herein by reference.

### TECHNICAL FIELD

This invention relates to water desalination and hydrogen production.

### BACKGROUND

Hydrogen has attracted considerable commercial interest for use in transportation, heating and other applications as a potential alternative to fossil fuels. Because hydrogen production typically requires considerable energy input, hydrogen represents an energy carrier rather than an energy source. Common hydrogen production methods include steam methane reforming (SMR) and auto thermal reforming (ATR). In SMR, a high temperature reaction of methane with steam produces hydrogen and carbon dioxide. In ATR, a hydrocarbon feed is partially oxidized with oxygen and steam to produce a synthetic gas (syngas) composed of hydrogen, carbon monoxide and carbon dioxide, followed by a catalytic reforming step and separation of the hydrogen, carbon monoxide and carbon dioxide. SMR and ATR may also be combined with one another. If the carbon dioxide produced in SMR or ATR is released to the atmosphere, then the hydrogen production is sometimes referred to as “gray hydrogen”. If the carbon dioxide from SMR or ATR is captured, then the hydrogen production is sometimes referred to as “blue hydrogen”.

So-called “green hydrogen” is hydrogen produced by splitting water via electrolysis using a renewable energy source, such as wind power, solar power, hydroelectric power or tidal energy, to produce only hydrogen and oxygen, and without carbon dioxide as a byproduct. Although several green hydrogen projects have been suggested, most are proposals or pilot projects. An example is the “Deep Purple” pilot project from TechnipFMC plc, which will use offshore wind turbines (and fuel cells when wind power is insufficient) to power an offshore platform-mounted reverse osmosis (RO) desalination unit and electrolyzer. Hydrogen from the electrolyzer may be piped ashore or stored in tanks on the seabed. Hydrogen production using land-based (viz., onshore) desalination plants has also been proposed.

Present estimates are that green hydrogen represents only about 1% of current worldwide hydrogen production. Further improvements in the required capital expense and energy usage will likely be needed before green hydrogen production comes into widespread use. From the foregoing, it will be appreciated that what remains needed in the art are improved systems and methods for hydrogen production having reduced environmental impact and offering one or more of lower energy costs, lower capital costs, lower operating costs or lower maintenance expense. Such systems are disclosed and claimed herein.

### SUMMARY

Compared to land-based water separation, a submerged water desalination system can

provide several important advantages. For example, submerged operation can significantly reduce both pump power requirements and capital expenditures, since hydrostatic pressure can provide much or all of the driving force required for desalination, and a lower cost, reduced strength pressure containment vessel can be employed to house the desalination apparatus or even dispensed with entirely.

The disclosed invention provides in one aspect a green hydrogen production system comprising:
a. an offshore platform that is on or secured to a seabed, or is moored, submerged or floating in seawater;
b. an offshore renewable energy source that supplies power to the platform;
c. a water desalination apparatus that is submerged in seawater and supplies desalinated water to a first conduit;
d. a water electrolysis apparatus that is on or secured to the seabed, platform or water desalination apparatus, or is moored, submerged or floating in seawater, and which receives power from the renewable energy source and desalinated water from the first conduit, and produces hydrogen and oxygen from the supplied desalinated water; and
e. a tank or second conduit for storage or transmission of the produced hydrogen.

The disclosed invention provides in another aspect a method for green hydrogen production, the method comprising the steps of:
a. producing power from an offshore renewable energy source;
b. supplying such power to an offshore platform that is on or secured to a seabed, or is moored, submerged or floating in seawater;
c. producing desalinated water from a water desalination apparatus that is submerged in seawater and which supplies the desalinated water to a first conduit;
d. producing hydrogen and oxygen from a water electrolysis apparatus that is on or secured to the seabed, platform or water desalination apparatus, or is moored, submerged or floating in seawater, and which receives power from the renewable energy source and desalinated water from the first conduit; and
e. storing or transmitting the produced hydrogen in a tank or second conduit.

The disclosed system and method combine an offshore renewable energy source with a submerged “Natural Ocean Well” to enable green hydrogen production with reduced energy use or capital cost compared to either onshore systems or offshore systems that do not employ a submerged desalination apparatus.

### BRIEF DESCRIPTION OF THE DRAWING

FIG. 1 and FIG. 2 are schematic side views of two embodiments of the disclosed system and method.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, an apparatus that contains “a” reverse osmosis membrane includes “one or more” such membranes.

The term “brine” refers to an aqueous solution containing a materially greater sodium chloride concentration than that found in typical saltwater, viz., salinity corresponding to greater than about 3.5% sodium chloride. It should be noted that different jurisdictions may apply differing definitions for the term “brine” or may set different limitations on saline discharges. For example, under current California regulations, discharges should not exceed a daily maximum of 2.0 parts per thousand (ppt) above natural background salinity measured no further than 100 meters horizontally from the discharge point. In other jurisdictions, salinity limits may for example be set at levels such as 1 ppt above ambient, 5% above ambient, or 40 ppt absolute.

The term “concentrate” refers to a desalination apparatus discharge stream having an elevated salinity level compared to ambient surrounding seawater, but not necessarily containing sufficient salinity to qualify as brine in the applicable jurisdiction where such stream is produced.

The term “conduit” refers to a pipe or other hollow structure (e.g., a bore, channel, duct, hose, line, opening, passage, riser, tube or wellbore) through which a liquid flows during operation of an apparatus employing such conduit. A conduit may be but need not be circular in cross-section, and may for example have other cross-sectional shapes including oval or other round or rounded shapes, triangular, square, rectangular or other regular or irregular shapes. A conduit also may be but need not be linear or uniform along its length, and may for example have other shapes including tapered, coiled or branched (e.g., branches radiating outwardly from a central hub).

The term “depth” when used with respect to a submerged apparatus or a component thereof refers to the vertical distance, viz., to the height of a water column, from the free surface of a body of water in which the apparatus or component is submerged to the point of seawater introduction into the apparatus or to the location of the component.

The terms “desalinated water”, “fresh water” and “product water” refer to water containing less than 1000 parts per million (ppm), and more preferably less than 500 ppm, dissolved inorganic salts by weight. Exemplary such salts include sodium chloride, magnesium sulfate, potassium nitrate, and sodium bicarbonate.’

The term “offshore” refers to an apparatus, system or method that is situated or performed at sea, and at some distance from the shore.

The term “onshore” refers to an apparatus, system or method that is situated or performed on land.

The term “platform” refers to a supporting surface, typically level and flat, and typically raised with respects to its surroundings, on which equipment may be mounted. Offshore platforms may in some embodiments be non-level, non-flat, or partially or wholly submerged.

The term “recovery ratio” when used with respect to a desalination apparatus means the volumetric ratio of product water (permeate) produced by the apparatus to feedwater introduced to the apparatus.

The term “renewable energy source” refers to wind power, solar power, tidal energy, underground thermal energy or other clean energy source that comes from natural sources or processes that are continually replenished.

The term “seawater” refers to water containing more than 0.5 ppt dissolved inorganic salts by weight, and thus encompassing both brackish water (water containing 0.5 to 3.0 ppt dissolved organic salts by weight) as well as ocean water or other water containing more than 3.0 ppt dissolved organic salts by weight. In oceans, dissolved inorganic salts typically are measured based on Total Dissolved Solids (TDS), and typically average about 35 ppt TDS, though local conditions may result in higher or lower levels of salinity.

The term “submerged” means underwater.

The term “submersible” means suitable for use and primarily used while submerged.

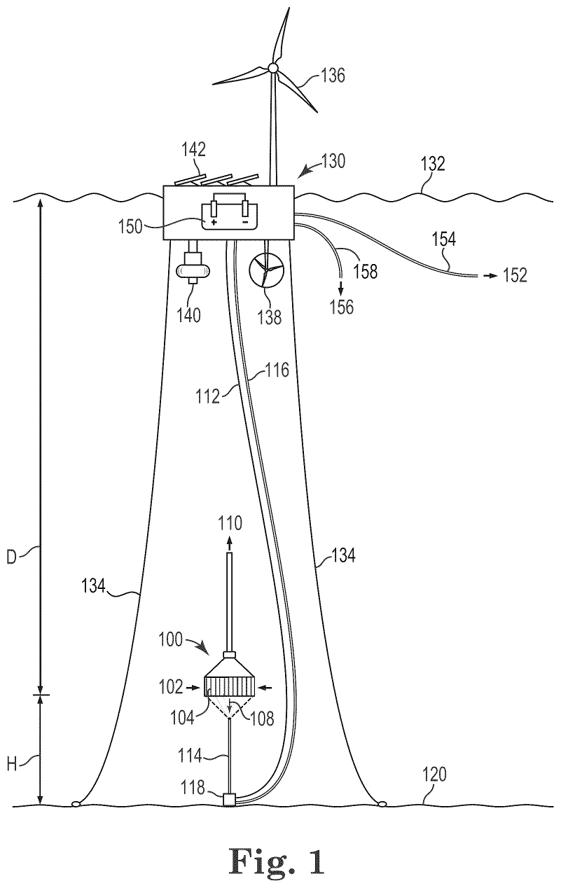

Referring first to FIG. 1, submerged desalination apparatus (viz., Ocean Well) 100 is shown in schematic side view. Raw seawater (viz., feedwater) 102 enters Ocean Well 100 via prefilter screens 104, and is separated inside Ocean Well 100 by suitable desalination devices (for example, RO membranes not shown in FIG. 1) into product water permeate stream 108 and concentrate or brine discharge stream 110. Power is supplied to Ocean Well 100 via umbilical 112, and permeate 108 is removed from Ocean Well 100 via downwardly-directed conduit 114 and upwardly-directed conduit 116. In the embodiment shown in FIG. 1, both the power and permeate 108 pass through a single point anchor 118 lodged, anchor-bolted or otherwise secured to seabed 120. A wet-mate hot-stab connector (not shown in FIG. 1) inside anchor 118 facilitates disconnection and servicing of Ocean Well 100 when necessary or convenient.

Floating platform 130 at seawater surface 132 is secured to seabed 120 via catenary mooring lines 134. Platform 130 may be secured or maintained in place using a variety of other devices, including piles, mooring buoys, buoyancy devices such as ring floats, motorized propulsion and other measures that will be familiar to persons having ordinary skill in the maritime arts. For example, platform 130 may be a component of, moored to, or suspended from an offshore oil or gas platform, offshore wind farm support, bridge pier or other partly or wholly submerged supporting structure. Power is supplied to platform 130 by an offshore renewable energy source such as any one or more of wind turbine generator 136, underwater (viz., tidal) turbine 138, wave energy generator 140 or solar panels 142. As depicted in FIG. 1, renewable energy sources 136, 138, 140 and 142 are mounted on platform 130 but they may also be placed nearby (e.g., within about 100, about 1,000 or about 10,000 meters from platform 130) and electrically connected to platform 130 or equipment thereon by suitable electrical cables. For example, renewable energy may be supplied from a nearby windfarm having a plurality of wind turbine generators 136. If the required power for operation of the disclosed system will exceed the power available from the chosen renewable energy source, then supplemental power may in some embodiments be provided by a suitable onshore power source, including renewable sources such as wind turbine generators, solar panels and hydroelectric power plants; low carbon emission sources such as nuclear power plants, and if need be higher carbon emission sources such as a conventional fossil-fueled power plant.

Power from the renewable or other energy source(s) and electrolyzer 150 are used to split desalinated water (viz., permeate) 108 from Ocean Well 100 into hydrogen 152 and oxygen 156. The thus-produced hydrogen 152 may be supplied to a suitable offshore recipient (for example, to a ship or other suitable vessel, not shown in FIG. 1, for use as fuel or for transport elsewhere), stored topside atop platform 130 or subsea on or near seabed 120 in a suitable storage tank (not shown in FIG. 1) or other facility, or sent (e.g., piped) onshore via conduit 154. The thus-produced oxygen 156 may be vented to the atmosphere, sent through conduit 158 to be injected or otherwise dispersed into the surrounding seawater at any desired depth (e.g., to reduce hypoxia), supplied to a suitable offshore recipient (for example, to a ship or other suitable vessel, not shown in FIG. 1, for transport elsewhere), stored topside atop platform 130 or subsea on or near seabed 120 in a suitable storage tank (not shown in FIG. 1) or other facility, or sent onshore via a suitable conduit (not shown in FIG. 1).

In the embodiment shown in FIG. 1, Ocean Well 100 is shown at depth D below surface 132. A variety of devices that will be familiar to persons having ordinary skill in the maritime arts may be used to secure Ocean Well 100 in place and maintain it at a desired position, depth D and appropriate height H with respect to seabed 120, including the platform 130 devices mentioned above, suspension cables from platform 130 or its support, or (as shown in FIG. 1) conduit 114 and single point anchor 118. Depth D preferably is such that the hydrostatic pressure of seawater at depth D is sufficient to drive seawater 102 through Ocean Well 100 and produce product water 108 and concentrate or brine 110 at a desired overall volume and recovery ratio without the need for additional pumps or other measures to pressurize seawater 102 on the inlet side of Ocean Well 100. The chosen depth D will vary based on several factors including the pressure drop across the above-mentioned prefilter screens 104; the type, dimensions and arrangement of RO cartridges or other desalination devices within Ocean Well 106; the type, sizing and operating conditions of permeate conduits 114 and 116; and the type, sizing and operating conditions of any needed pumps in Ocean Well 100. For example, if operating the disclosed desalination apparatus using HYDRANAUTICS™ SWC cylindrical membrane cartridges from Nitto Hydranautics operated without pumps to pressurize the inlet seawater, then operation at a depth of at least about 350 m together with a pump to draw product water from the RO membranes is preferred in order to minimize or eliminate the need for a high pressure vessel surrounding the RO membranes. In some prior submerged desalination apparatus designs, especially those that rely on a pressure pump to force seawater through the membranes, thick pressure-resistant vessels are employed to contain the high pressures needed for water desalination. In preferred embodiments of the present desalination apparatus, the prefilter elements and RO membranes or other desalination devices will not require pressure-resistant vessels, as they will already be immersed at a sufficiently high pressure in the fluid to be purified. Desirably the disclosed desalination apparatus merely maintains a sufficiently low pressure on the permeate discharge side, and a sufficient inlet side-outlet side pressure differential, so as to allow proper desalination device operation without the use of a surrounding pressure-resistant vessel.

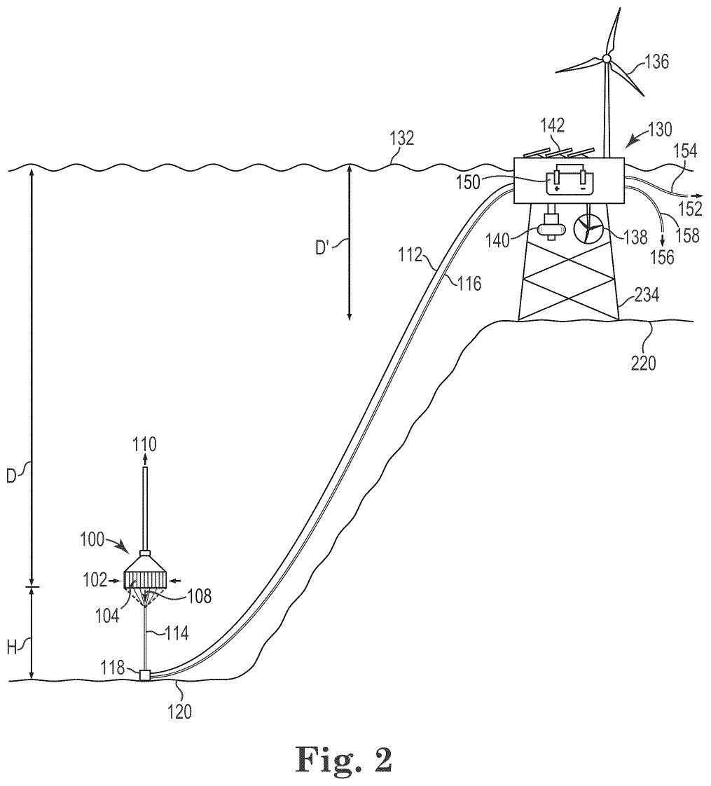

FIG. 2 shows a system like that in FIG. 1, but in which seabed 120 slopes upward to reach shelf 220 having a lesser depth D′ than depth D. Platform 110 consequently can be rigidly mounted on underwater platform support 234 at reduced and thus less expensive depth D′ while still permitting operation of submerged desalination apparatus 100 at deeper and thus greater hydrostatic pressure depth D.

The disclosed desalination apparatus may if desired be operated at greater depths than those needed for operation without a pressure vessel (e.g., at least about 400, at least about 450, at least about 500, at least about 550, at least about 600, at least about 650, at least about 700, at least about 750, at least about 800, at least about 900 or at least about 1,000 m), with operation at such greater depths increasing the pump suction head and inlet pressure, or enabling the elimination of one or more pumps from the disclosed system, or enabling use of the same model pump as might be employed at lesser depths. Such lesser depths may for example be at least about 300, at least about 200 or at least about 100 m, with operation at such lesser depths typically requiring at least one pump to help push seawater through the desalination apparatus (or a suitable vacuum assist on the outlet side) in order to achieve efficient desalination, and possibly also requiring a pressure vessel surrounding and protecting the RO membranes or other desalination devices. Overall exemplary depths for operation of the disclosed submerged desalination apparatus are for example from just below the surface (e.g., from about 10 m), from about 100 m, from about 300 m, or from about 500 m, and up to about 2,000 m, up to about 1,500 m or up to about 1,000 m. Depending on the chosen pump if any and desalination devices, preferred depths are from just below the surface to as much as 1500 m depth. Near the surface, the hydrostatic pressure of the ocean typically will need to be augmented by mechanical pumping to provide the pressure differential needed for water separation.

In the disclosed apparatus, raw seawater, product water and concentrate or brine may each flow in a variety of directions, e.g., upwardly, downwardly, horizontally, obliquely or any combination thereof. In the embodiments shown in FIG. 1 and FIG. 2, reverse osmosis membranes or other desalination devices within Ocean Well 100 are oriented so that concentrate or brine 110 is discharged generally upwardly and permeate 108 is discharged downwardly. Further details regarding such a desalination apparatus and replaceable RO modules, pumps and other components for use therein may be found in U.S. Pat. No. 11,174,877 B2 entitled SUBMERGED REVERSE OSMOSIS DESALINATION SYSTEM, in copending application Ser. No. 16/484,363 filed Aug. 7, 2019 and entitled BRINE DISPERSAL SYSTEM, and in International Application Nos. WO 2021/087468 A1 entitled THERMAL ENERGY CONVERSION SUBMERGED REVERSE OSMOSIS DESALINATION SYSTEM, WO 2021/087469 A1 entitled SUBMERGED WATER DESALINATION SYSTEM WITH REPLACEABLE DOCKABLE MEMBRANE MODULES, WO 2021/087470 A1 entitled SUBMERGED WATER DESALINATION SYSTEM WITH PRODUCT WATER PUMP CAVITATION PROTECTION, WO 2021/087471 A1 entitled SUBMERGED WATER DESALINATION SYSTEM PUMP LUBRICATED WITH PRODUCT WATER, WO 2021/087472 A1 entitled SUBMERGED WATER DESALINATION SYSTEM WITH REMOTE PUMP and WO 2021/087473 A1 entitled ADHESIVELY-BONDED WATER SEPARATION CARTRIDGE MODULE, each of which International Applications was filed on Nov. 2, 2020 and the disclosures of each of which are incorporated herein by reference.

Depth D may moreover be a fixed depth chosen at the time of installation, or an adjustable depth that may for example be changed following submerged desalination apparatus startup or changed in response to changing conditions (e.g., changing wave, tidal, thermocline or halocline conditions, changing seawater salinity, sea level rise, or changes in the operating efficiency of the RO membranes). In further embodiments, the disclosed submerged desalination apparatus may include a pressure-seeking capability to enable the system to increase or decrease its depth in order to obtain desired hydrostatic pressures, to optimize or adjust RO operating conditions or to optimize or adjust product water and concentrate or brine delivery.

By way of example, if the disclosed apparatus is operated at a depth of about 700 m, hydrostatic pressure will provide approximately 68 bar on the high-pressure side of a semi-permeable RO membrane. When used with a presently preferred backpressure of 13 bar or less on the product discharge side of the membrane, this will result in a pressure differential across the membrane of 55 bar (approximately 800 psi) or more. In situations of higher-or lower-salinity waters, these depth and pressure values may vary. The inlet pressure will in any event normally be the ocean hydrostatic pressure at the chosen desalination apparatus operating depth.

The preferred depth and pressure values set out above may vary in systems that take advantage of future developments enabling or requiring lower or higher differential pressures or higher or lower backpressures on the RO membranes or other desalination devices. Adjustments to accommodate such developments may increase or decrease the preferred operating depth for the disclosed desalination apparatus. For example, in many RO membranes the pressure on the low-pressure side typically will not change appreciably with depth, and consequently changing the depth of operation may suffice to adjust the differential pressure across the membranes and achieve optimal operating conditions.

The heights H (the vertical spacing between the lowest inlets to prefilter screens 104 and seabed 120) may for example represent at least about 3, at least about 5, at least about 10, at least about 20, at least about 40 or at least about 50 m. Lesser heights H may be employed. For example, height H may be reduced to near zero or zero, so that the inlets to prefilter screens 104 are near or at the same depth as seabed 120. However, doing so typically will increase the turbidity of seawater 102 entering the prefilters 104 and the possibility that foreign matter may be drawn through the prefilters 104 and into the Ocean Well 100.

The various pumps referred to herein may be selected from a wide variety of submersible single stage or multistage pumps, including piston (e.g., axial piston), plunger, rotary (e.g., centrifugal impeller pumps and rim-driven shaftless thrusters) and screw pumps that may use a variety of flow schemes including positive displacement, centrifugal and axial-flow principles. Suitable pumps are available from a variety of sources that will be familiar to persons having ordinary skill in the desalination art, and may in appropriate instances be adapted from other fields such as subsea oil and gas production, and marine (including submarine) positioning and propulsion. Exemplary pump suppliers include Brunvoll, Cat Pumps, Copenhagen Subsea, Danfoss, Enitech, FMC Kongsberg Subsea AS, Fuglesang Subsea AS, Halliburton, Hayward Tyler, Ocean Yacht Systems, Parker, Rolls Royce, Schlumberger, Schottel, Silent Dynamics, Technical Supply & Logistics, Vetus and Voith. In some embodiments the disclosed pumps include hot-swap connectors to enable them to be removed from the disclosed apparatus while it is submerged, for replacement, repair or rebuilding.

When operated at sufficient depth, Ocean Well 100 will not need to include a pressure vessel, and may instead mount its components in or on a lightweight supporting frame or other housing made from relatively inexpensive and suitably corrosion-resistant materials such as a corrosion-resistant metal skeleton or a housing made from a suitable plastic, fiber-reinforced (e.g., glass fiber-or carbon fiber-reinforced) plastic or other composite, or a variety of other unreinforced or engineered plastics the selection of which will be understood by persons having ordinary skill in the art. Avoiding the need for a pressure vessel greatly reduces the required capital expenditure (CAPEX) for constructing Ocean Well 100 compared to the costs for constructing a shore-based desalination apparatus. If using a plurality of individual desalination devices (for example, RO cartridges containing spiral-wound membranes), then avoidance of pressure vessels also enables the devices to be economically deployed using a parallel array containing a significantly larger number of devices than might normally be employed in a shore-based desalination apparatus, and operating the individual devices at a lower than normal individual throughput. For example, the number of cartridges or other desalination devices may be at least 10% more, at least 15% more, at least 20% more or at least 25% more than might normally be employed in an onshore desalination apparatus. Doing so can help extend the life of individual desalination devices while still providing a desired daily amount of product water. In the embodiments shown in FIG. 1 and FIG. 2, a large array of parallel desalination devices (e.g., cylindrical RO cartridges) preferably are operated not only at low individual throughput, but also with a reduced recovery rate. Doing so can also provide reduced concentrate salinity, reduced fouling potential, and in preferred embodiments will result in a large volume of concentrate that does not qualify as brine in the applicable jurisdiction. Exemplary recovery ratios may for example be no greater than 40%, no greater than 30%, no greater than 20%, no greater than 15%, no greater than 10%, no greater than 8% or no greater than 6%, and may for example be less than 3%, at least 3%, at least 4% or at least 5%. The chosen recovery ratio will depend upon factors including the selected desalination devices, and the depth and applicable jurisdiction in which the desalination apparatus operates. The chosen recovery ratio also influences pump sizing and energy costs. By way of example, for an embodiment employing Dow FILMTEC RO membrane cartridges to treat seawater with an average 34,000 ppm salinity at an 8% recovery ratio, about 8% of the seawater inlet stream will be converted to product water having less than 500 ppm salinity, and about 92% of the seawater inlet stream will be converted to a low pressure or unpressurized brine stream having about 37,000 ppm salinity. By way of a further example, a submerged desalination apparatus employing Nitto

Hydranautics RO membrane cartridges operated at a depth of about 500 m and a 5% recovery ratio may be used to produce concentrate that does not qualify as brine under the current version of the California Water Quality Control Plan.

In some embodiments, the disclosed desalination apparatus operates at a depth of at least about 350 m, does not employ seawater pumps on the RO membrane inlet side, and employs a product (fresh) water pump on the outlet side of the RO membranes to maintain at least a 27 bar and more preferably at least a 30 or 35 bar pressure differential across the membranes, to allow the ocean's hydrostatic pressure to force or to largely help force product water through such membranes. Advantages for such a configuration include a pump requiring much less energy when located at the membrane outlet rather than at the inlet, and the avoidance of, or much lower requirements for, any pressure vessels housing the membranes. Use of membranes with a low required pressure differential will enable operation at lesser depths or using smaller pumps. Currently preferred such membranes include Nitto Hydranautics SWC6-LD membrane cartridges (40 bar differential pressure) and LG Chem LG-SW-400-ES membrane cartridges (38 bar differential pressure). For example, by using about 1700 of the above-mentioned Nitto

Hydranautics cartridges, the disclosed desalination apparatus may produce about 5 million gallons per day when operated at a 5% recovery rate. Other RO membrane suppliers whose cartridges may be used will be apparent to persons having ordinary skill in the art, and include Aquatech International, Axcon Water Technologies, DuPont Water Solutions (makers of the above-mentioned DOW FILMTEC cartridges), Evoqua Water Technologies, GE Water and Process Technologies and Koch Membrane Systems, Inc. Customized cartridges having altered features (for example, wider gaps between layers, modified spacers, a looser membrane roll, a modified housing or modified ends) may be employed if desired.

A wide variety of renewable energy sources may be employed in the disclosed system. Suitable wind turbine generators include those available from Alstom, Areva Turbine Company, Clipper Windpower, Doosan Heavy Industries and Construction, Gamesa Technology, GE Power, Senvion, Siemens, Sinovel and Vestas. Suitable underwater turbines include those available from Nova Innovation. Suitable wave energy generators include devices under development by CalWave Power Technologies, Inc. Suitable solar panels include both platform-mounted and floating designs such as those available from Kyocera Corporation.

As discussed above, Ocean Well 100 may if desired be additionally supplied with power from a conventional platform-mounted, ship-borne or onshore power source, for example an onshore power plant. Doing so may result in greater carbon emissions than when using the disclosed renewable energy sources, but may be desirable in instances in which the disclosed renewable sources are not able to provide sufficient power or are not able to do so at all times or seasons when such power may be needed.

The disclosed desalination apparatus may be operated in a variety of locations. In some embodiments, the apparatus is deployed above an ocean dropoff or above or in an ocean trench (for example, the waters surrounding the Hawaiian Islands, the Monterey Submarine Canyon, Puerto Rico Trench, Ryukyu Trench, and other accessible deep sea sites that will be familiar to persons having ordinary skill in the art). In some embodiments, the apparatus is deployed, near a populated or unpopulated area in need of hydrogen and optionally near a populated or unpopulated area in need of surplus desalinated water. The desalination apparatus inlet surfaces need not be placed at ocean or trench floor depth, and may instead be positioned at a depth sufficient to enable the use of hydrostatic pressure to drive seawater through the osmotic membranes, for example by suspending the apparatus from or on a floating or seabed-mounted platform, or placing it along a trench wall or dropoff wall. Desirably however the apparatus is not placed in or near an area that may be subject to high turbidity or underwater avalanches.

Operation at appropriate depths can greatly reduce or eliminate the likelihood of algal bloom contamination, which can cause conventional shore-based plants with shallow water intakes to shut down in order to avoid toxins and clogging. Operation at such appropriate depths can also minimize or eliminate the loss of marine life, as most marine organisms are found within the photic zone (depending upon water clarity, corresponding to depths up to about 200 m) and thus at deeper depths will not be drawn into the desalination apparatus intake or against a prefilter screen.

The cold feedwater (e.g., 5-10° C. water) typically encountered at the above-mentioned recommended operating depths can provide several useful advantages. For example, the feedwater is relatively free from critical organic and inorganic contaminants. It carries very little organic matter or chlorophyll and thus contains little bacteria, while still retaining valuable nutrients from the ionic minerals and trace elements present at the disclosed pressures and depths. A further advantage arises in connection with boron removal, which is important for irrigation water and health purposes. Boron is present in seawater, and at conventional RO operating temperatures such as are used in onshore RO units, enough boron may pass through the RO membrane to inhibit the growth of plants. Boron removal to agricultural standards of 0.5 mg/liter in a conventional RO facility may require double treatment of the water using a second RO pass, thus increasing capital and operating costs. Boron removal by reverse osmosis is however highly temperature-dependent, with lower amounts of boron and its salts passing through the membranes at colder temperatures. For example, borate passage may be reduced by several percentage points for every reduction of 10° C. in feedwater temperature. Placement of the disclosed system in cold deep water consequently may help produce high-quality surplus desalinated water (e.g., for use as potable water or in agriculture), beyond that needed for green hydrogen production, by improving the removal of boron and its salts while saving the energy, capital, and maintenance costs required for a double treatment system. Cold feedwater may also result in less overall salt passage through an RO membrane or other desalination device, allowing for remineralization of the product water for taste reasons while maintaining a low level of TDS to meet regulatory requirements. In addition, the use of cold feedwater can nearly eliminate the scaling of membranes by mineral deposition, as measured by the Langelier Index. Membrane scaling can be a problem with shore-based, shallow-intake RO units, and reduces system efficiency and lifetime. In the disclosed desalination apparatus, scaling is minimized because CO₂ will tend to be in equilibrium at the 5-10° C. temperatures at which the apparatus may be operating. This can eliminate the need for the anti-scaling chemicals that often are employed in shore-based RO units. Biofilm growth, another form of membrane fouling, is also temperature-dependent, with more biofilm forming at warmer temperatures, and less at the low-temperature preferred operating environment of the disclosed desalination apparatus. Biological activity and hence biological fouling are thus reduced due to the use of water from a region having no light, low oxygen, and cold water temperatures.

The disclosed desalination apparatus can produce significantly lower concentrations of salt in the brine stream than will be the case for a conventional onshore desalination apparatus, as the elimination of the requirement for pressure vessels permits the RO membranes or other desalination devices to be arrayed in parallel rather than the typical seawater desalination industry practice of 5-7 RO membrane cartridges in a serial arrangement. A parallel array eliminates a common failure point in conventional RO systems, namely the O-ring interconnections between membranes. A parallel arrangement also permits higher product water production per membrane. In addition, a parallel arrangement creates much less salty concentrate or brine than a train of single RO membranes operating in series, and the salinity of such concentrate or brine can easily be adjusted by altering the recovery ratio. The ability of the disclosed desalination apparatus to achieve low brine salinity is beneficial to sea life and allows easier dilution of the concentrate or brine. For example, when supplied with Southern California seawater containing about 34,250 ppm ambient TDS and operated at a 5% recovery ratio, the disclosed apparatus may provide concentrate containing only about 36,049 TDS versus the near-doubling in discharge stream salinity that may arise using conventional serially-configured onshore RO. A 36,049 ppm TDS discharge stream would be less than 1800 ppm above ambient, and thus well within the current brine discharge limit of 2,000 ppm above ambient TDS for California waters.

A variety of water electrolysis apparatuses (viz., electrolyzers) may be employed in the disclosed system. Suitable electrolyzers include those available from Accagen SA, Beijing CEI Technology Co., Ltd., ELB Elektrolyse Technik GmbH, Gaztransport & Technigaz, Giner Inc., Green Hydrogen Systems, Hydrogenics Corp., Igas Energy plc, McPhy Energy S.A., Nel Hydrogen, Next Hydrogen Solutions, and Tianjin Mainland Hydrogen Equipment Co. Ltd. Hydrogen produced by the electrolyzer may as noted above be supplied to an offshore recipient, stored topside or subsea in a suitable storage tank or other facility, or sent onshore. Oxygen produced by the electrolyzer may be supplied to an offshore recipient, stored topside or subsea in a suitable storage tank or other facility, sent onshore, or injected or otherwise dispersed into the surrounding seawater at any desired depth.

A principal benefit of the overall disclosed system and method is its significantly reduced energy and capital requirements. The artificial pressurization of process water, the largest source of energy use in conventional RO desalination, can be reduced or eliminated. The associated capital expenditures and operating expenditures can likewise also be significantly reduced, especially in comparison with those required for offshore platform-mounted or onshore desalination. These and other advantages of the disclosed system and method thus may include one or more of:
Greatly reduced power consumption (thus providing more energy for carrying out electrolysis, or enabling construction of a smaller windfarm or other renewable energy source).
Reduced greenhouse gas emissions to produce a given quantity of hydrogen.
Elimination of the artificial high-pressure environment used in conventional desalination and the accompanying pressure vessels, high pressure piping, and fittings.
Reduced operation and maintenance requirements through elimination of parts, and especially the reduction of highly-pressurized connections.
Fewer precision parts requiring expensive alloys and other exotic materials resistant to seawater corrosion.
Reduced or eliminated pretreatment equipment and its associated operating capital and labor.
Reduced localized brine emission.
Reduced bacterial content and bacterial fouling due to the use of deep-sea intake water that is relatively free of undesirable organic or inorganic contaminants.
Avoiding the excess sludge production that results when using onshore or platform-mounted desalination units.
Reduced susceptibility to desalination disruption caused by algal blooms.
Reduced visibility or invisibility from shore.
Reduced susceptibility to destruction due to adverse weather events, fires, terrorism or volcanic eruptions.
Reductions by as much as 100% in required onshore real estate.
Suitability for deployment as an “Ocean Well” that can provide a sustained freshwater supply without aquifer depletion.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A green hydrogen production system comprising:
a. an offshore platform that is on or secured to a seabed, or is moored, submerged or floating in seawater;
b. an offshore renewable energy source that supplies power to the platform;
c. a water desalination apparatus that is submerged in seawater and supplies desalinated water to a first conduit;
d. a water electrolysis apparatus that is on or secured to the seabed, platform or water desalination apparatus, or is moored, submerged or floating in seawater, and which receives power from the renewable energy source and desalinated water from the first conduit, and produces hydrogen and oxygen from the supplied desalinated water; and
e. a tank or second conduit for storage or transmission of the produced hydrogen.

2. A system according to claim 1, wherein the offshore platform is on or secured to the seabed.

3. A system according to claim 1, wherein the offshore platform is submerged in seawater.

4. A system according to claim 1, wherein the offshore platform is floating in seawater.

5. A system according to claim 1, wherein the offshore renewable energy source comprises one or more wind turbine generators.

6. A system according to claim 1, wherein the offshore renewable energy source comprises one or more underwater turbines or wave energy generators.

7. A system according to claim 1, wherein the offshore renewable energy source comprises one or more solar panels.

8. A system according to claim 1, wherein the submerged water desalination apparatus has an inlet for seawater and outlets for desalinated water and concentrate or brine, and operates at a depth sufficient to drive seawater into the desalination apparatus and form desalinated water without the need for a pressure-resistant vessel surrounding the desalination apparatus.

9. A system according to claim 1, wherein the submerged water desalination apparatus has an inlet for seawater and outlets for desalinated water and concentrate or brine, and operates at a depth sufficient to drive seawater into the desalination apparatus and form desalinated water without the need for a pump to pressurize seawater at the inlet.

10. A system according to claim 1, wherein the submerged water desalination apparatus has an inlet for seawater and outlets for desalinated water and concentrate or brine, and includes at least one seawater inlet pump to help push seawater through the desalination apparatus.

11. A system according to claim 1, wherein the submerged water desalination apparatus operates at a depth of at least about 350 m.

12. A system according to claim 1, wherein the submerged water desalination apparatus comprises reverse osmosis membranes.

13. A system according to claim 1, wherein the submerged water desalination apparatus comprises a plurality of desalination devices arranged in a parallel array.

14. A system according to claim 1, wherein the submerged water desalination apparatus operates at a recovery rate no greater than 40%.

15. A system according to claim 1, wherein the submerged water desalination apparatus operates at a recovery rate no greater than 30%.

16. A system according to claim 1, wherein the water electrolysis apparatus is moored, submerged or floating in seawater.

17. A system according to claim 1, wherein hydrogen produced by the water electrolysis apparatus is supplied offshore to a ship or other suitable vessel, or wherein potable water is sent from the platform, water desalination apparatus or water electrolysis apparatus to ships or other nearby vessels, or wherein surplus power is sent from the platform or renewable energy source to ships or other nearby vessels.

18. A system according to claim 1, wherein hydrogen produced by the water electrolysis apparatus is sent onshore, or wherein potable water is sent onshore from the platform, water desalination apparatus or water electrolysis apparatus, or wherein surplus power is sent onshore from the platform or renewable energy source.

19. A system according to claim 1, wherein oxygen produced by the water electrolysis apparatus is injected into seawater to reduce hypoxia.

20. A method for green hydrogen production, the method comprising the steps of:
a. producing power from an offshore renewable energy source;
b. supplying such power to an offshore platform that is on or secured to a seabed, or is moored, submerged or floating in seawater;
c. producing desalinated water from a water desalination apparatus that is submerged in seawater and which supplies the desalinated water to a first conduit;
d. producing hydrogen and oxygen from a water electrolysis apparatus that is on or secured to the seabed, platform or water desalination apparatus, or is moored, submerged or floating in seawater, and which receives power from the renewable energy source and desalinated water from the first conduit; and
e. storing or transmitting the produced hydrogen in a tank or second conduit.
